(19) United States
(12) Patent Application Publication
(10) Pub. No.: US 2008/0141148 A1
(43) Pub. Date: Jun. 12, 2008

(54) IMAGE FORMING DEVICE AND DISPLAY CONTROL METHOD

(76) Inventor: Seiya OGITA, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/951,641

(22) Filed: Dec. 6, 2007

(30) Foreign Application Priority Data
Dec. 8, 2006 (JP) 2006-332446
Nov. 27, 2007 (JP) 2007-306422

(51) Int. Cl. G06F 3/00

(52) U.S. Cl. 715/762

(57) ABSTRACT

An image forming device is disclosed that is able to simplify customization of the display screen of an operational panel. The image forming device includes a unit for managing, in connection with each of plural display screen images to be displayed on the operational panel, composition information of displaying parts to be arranged on each of the display screen images; a unit for managing arrangement information of the displaying parts on each of the display screen images; a unit for managing displaying part data of each of the displaying parts; and a display control unit for acquiring the composition information and the arrangement information corresponding to the display screen image to be displayed, the displaying part data of the displaying part being defined by the composition information, and arranging the acquired displaying part in accordance with the arrangement information. The display control unit changes display conditions of the display screen image according to one or more of the composition information, the arrangement information, and the displaying part data.

### BACKGROUND OF THE INVENTION

1. Field of the Invention

The present invention relates to an image forming device and a display control method, and particularly, to an image forming device having an operational panel, and a display control method of the operational panel.

2. Description of the Related Art

In recent years, a liquid crystal panel (for example, a touch panel) of an operational panel of usual digital copiers has become larger and larger, and more and more contents are displayed by the liquid crystal panel. For example, display of a large variety by using icons can be realized by controlling software (below, referred to as “display software”), and this realizes a user-friendly user-interface.

For example, this technique is disclosed in Japanese Laid Open Patent Application No. 11-174910.

Along with the increasing variety of the contents displayed on a liquid crystal panel, it is desirable that the contents on the display be changeable depending on users' authority, preference and others. In addition, along with improved functions, sometimes it is necessary to add new display contents corresponding to newly added functions.

However, in the related art, the contents to be displayed on a display screen are included in the display software as logic, and thus, in order to customize the display contents, it is necessary to modify the source programs of the display software. Further, even when it is possible to customize the display contents depending for each user, the customizations are limited to the fixed choices embedded in the display software; thus, it is difficult to make flexible customizations.

Usually, display contents on the display screen of the image forming device are different depending on functions. But there are some common contents for various functions. In the related art, since logic related to the display contents (also referred to as “a screen”) is separately prepared for different functions, even for the common contents, customization has to be made separately for different functions.

### SUMMARY OF THE INVENTION

The present invention may solve one or more problems of the related art.

A preferred embodiment of the present invention may provide an image forming device and a display control method able to simplify customization of a display screen image of an operational panel.

According to a first aspect of the present invention, there is provided an image forming device having an operational panel, comprising:

a composition information management unit configured to manage composition information of displaying parts to be arranged on each of a plurality of display screen images, said display screen images being to be displayed on the operational panel, said composition information of the displaying parts being managed in connection with each of the display screen images;

an arrangement information management unit configured to manage arrangement information of the displaying parts on each of the display screen images;

a displaying part management unit configured to manage displaying part data of each of the displaying parts; and

a display control unit configured to acquire the composition information and the arrangement information corresponding to one of the display screen images to be displayed, the displaying part data of the displaying part being defined by the composition information, and arrange the acquired displaying part in accordance with the arrangement information,

wherein

the display control unit changes display conditions of the display screen image according to at least one of the composition information, the arrangement information, and the displaying part data.

According to the embodiment of the present invention, it is possible to simplify customization of the display screen of the operational panel.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a block diagram exemplifying a hardware configuration of an image forming device 1 according to an embodiment of the present invention;

FIG. 2 is a diagram illustrating the operational panel 104 according to the present embodiment of the present invention;

FIG. 3 is a block diagram exemplifying a software configuration of the image forming device 1 according to the present embodiment of the present invention;

FIG. 4 is a block diagram illustrating the framework contents 14 and the displaying contents 15 of the operational section 10;

FIG. 5 is a block diagram illustrating a class diagram of the framework contents 14;

FIG. 6 is a block diagram illustrating a class diagram of the displaying contents 15 for exemplifying class groups of the displaying contents 15;

FIG. 7 is a block diagram illustrating a relationship between an operational screen image and the template;

FIG. 8 is a diagram exemplifying a definition of the specification file 1504;

FIG. 9 is a diagram schematically exemplifying a definition of the layout file 1505;

FIG. 10 is a table exemplifying a screen composition information management table;

FIG. 11 is a block diagram illustrating the UI controller 24 and the logic unit 28 of the controller 20 according to the present embodiment;

FIG. 12 is a block diagram illustrating a class diagram of the UI controller 24 for exemplifying class groups of the UI controller 24;

FIG. 13 is a sequence diagram illustrating a display process of the operational screen image when the user does not login;

FIG. 14 is a sequence diagram illustrating a display process of the operational screen image when the user has completed login;

FIG. 15 is a block diagram exemplifying a customization setting screen image according to the present embodiment;

FIG. 16 is a sequence diagram illustrating a display process of a copy UI setting screen image;

FIG. 17 is a diagram exemplifying the URL information of the copy UI setting screen image;

FIG. 18 is a block diagram exemplifying the fixed portion of the copy UI setting screen image;

FIG. 19 is a diagram exemplifying the URL information of the copy screen image;

FIG. 20 is a block diagram exemplifying a complete copy UI setting screen image;

FIG. 21 is a sequence diagram illustrating a customization process of the copy screen image;

FIG. 22 is a diagram exemplifying the event notification data. In FIG. 22, as an example, the event notification data are written in the XML form;

FIG. 23 is a diagram exemplifying the condition updating instruction data;

FIG. 24 is a diagram exemplifying updating of the specification file 1504;

FIG. 25 is a diagram exemplifying the choices of destinations of the displaying parts;

FIG. 26 is a diagram exemplifying update of the specification file 1504 in response to changes of the arrangement positions of the displaying parts; and

FIG. 27 is a block diagram exemplifying a configuration of the image forming device 1 capable of remote customization.

### DESCRIPTION OF THE PREFERRED EMBODIMENTS

Below, preferred embodiments of the present invention are explained with reference to the accompanying drawings.

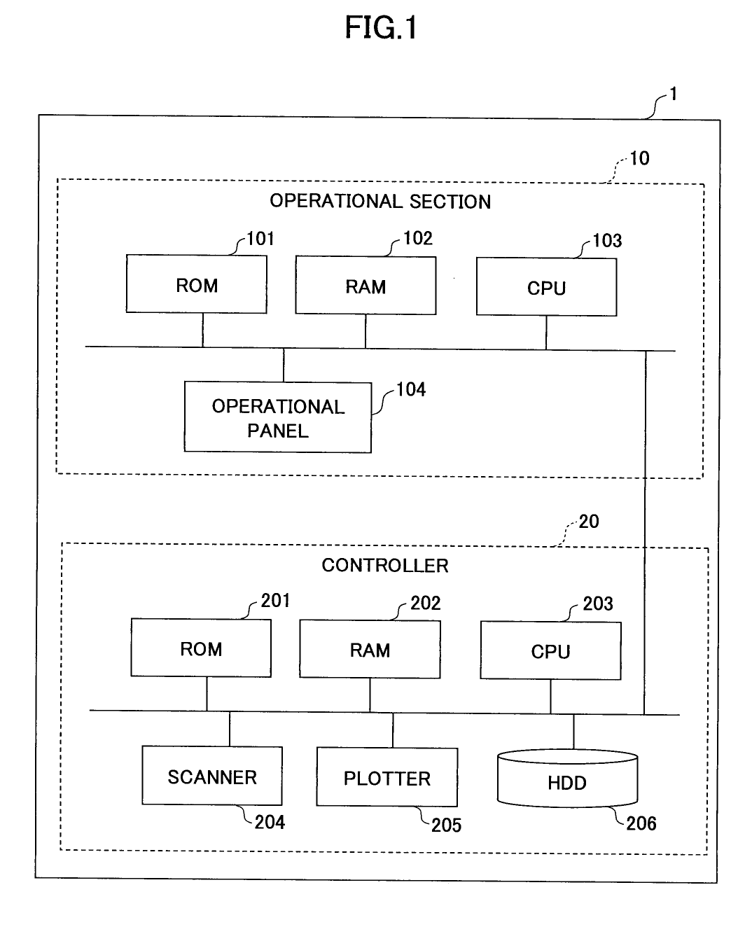

FIG. 1 is a block diagram exemplifying a hardware configuration of an image forming device 1 according to an embodiment of the present invention.

It should be noted that shown in FIG. 1 are primary hardware components of the image forming device 1.

As shown in FIG. 1, the image forming device 1 can be roughly divided into an operational section 10 and a controller 20. The operational section 10 includes a ROM 101, a RAM 102, a CPU 103, and an operational panel 104.

The operational section 10 performs display control of a display screen of the operational panel 104.

The ROM 101 stores programs for display control and data utilized by the programs.

The RAM 102 is used as a memory area when loading the above programs.

The CPU 103 executes the programs loaded in the RAM 102 to perform display processing of the operational panel 104.

The operational panel 104 is hardware for an operator to input data into the image forming device 1, and to obtain output results from the image forming device 1.

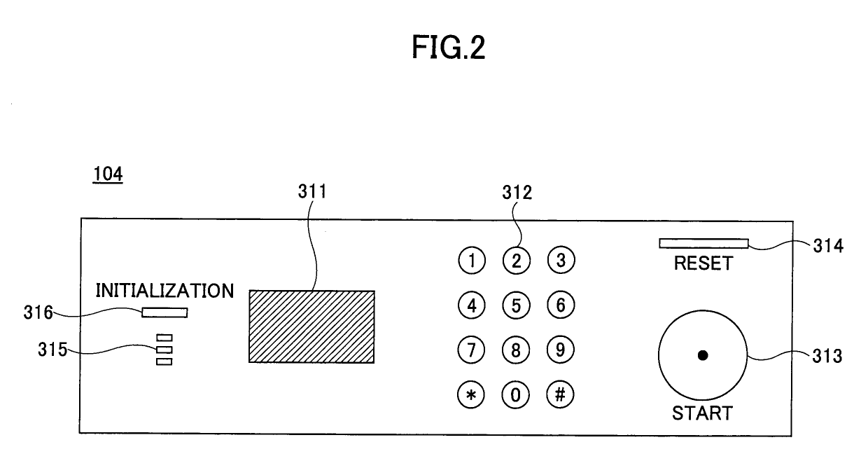

FIG. 2 is a diagram illustrating the operational panel 104 according to the present embodiment of the present invention.

As shown in FIG. 2, the operational panel 104 includes a touch panel 311, a keyboard 312, a start button 313, a reset button 314, a functional key 315, an initialization button 316.

The touch panel 311 is hardware for inputting data by touching (namely, a touch operational part), and for obtaining output displayed on the screen (a screen display part).

The keyboard 312 is hardware for inputting data by keystrokes (button operations).

The start button 313 is hardware to start operations by button operations.

The reset button 314 is hardware for resetting by button operations.

The functional key 315 is hardware for displaying various kinds of operational screen images by keystrokes or button operations.

The initialization button 316 is hardware for displaying an initialization setting screen image by button operations.

Returning to FIG. 1, the controller 20 includes a ROM 201, a RAM 202, a CPU 203, a scanner 204, a plotter 205, and a hard disk drive (HDD) 206. The controller 20 controls operations of the scanner 204 and the plotter 205, which are hardware resources for image data processing (image formation processing) in the image forming device 1.

The ROM 201 stores programs for realizing functions of the controller 20 and data utilized by the programs.

The RAM 202 is used as a memory area for loading the above programs when executing the programs.

The CPU 203 executes the programs loaded in the RAM 202 to realize functions of the controller 20.

The scanner 204 is a device (hardware resources) for reading image data from sheet material, such as a piece of paper.

The plotter 205 is a device (hardware resources) for outputting (printing) image data on sheet material, such as a piece of paper.

The hard disk drive (HDD) 206 provides a large scale storage medium for storing various kinds of information. For example, the hard disk drive (HDD) 206 is used to store image data read by the scanner 204.

The operational section 10 and the controller 20 are connected by buses or USB (Universal Serial Bus) cables. Input operations to the operational panel 104 are treated as events and reported to the controller 20, and the controller 20 performs processing according to the events. On the other hand, events detected in the controller 20 (for example, events generated by the scanner 204 and the plotter 205) are reported to the operational section 10, and the operational section 10 performs display processing in corresponding to the received events.

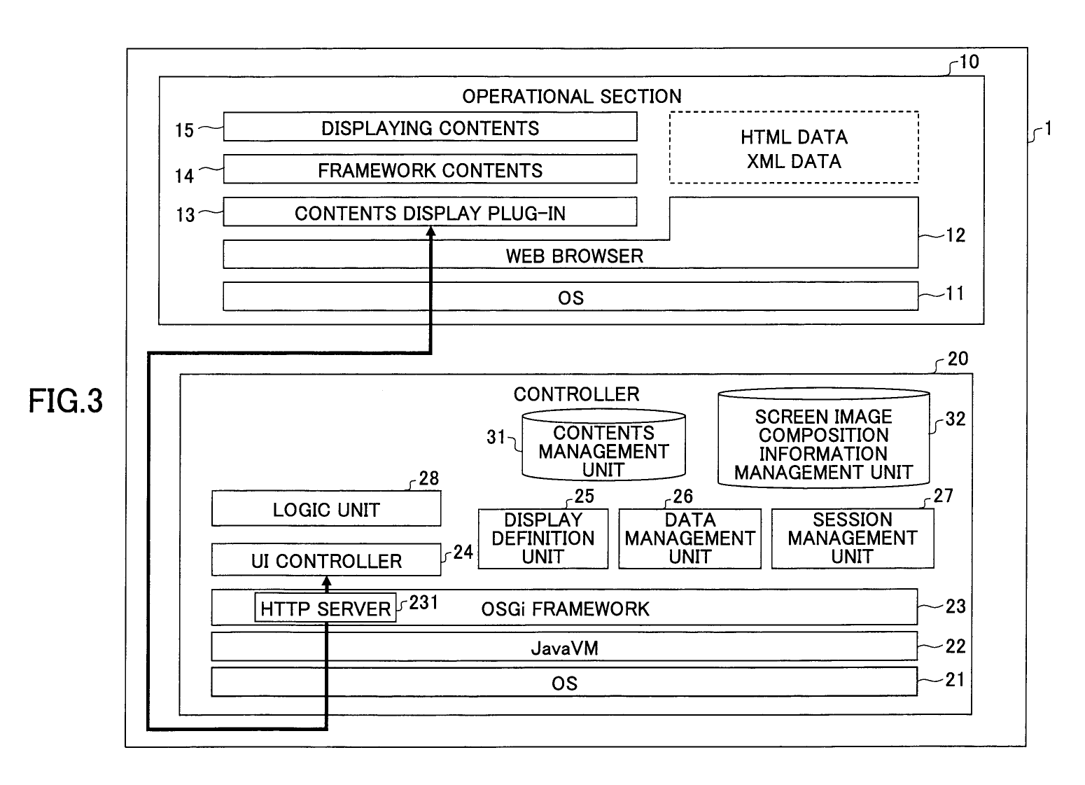

FIG. 3 is a block diagram exemplifying a software configuration of the image forming device 1 according to the present embodiment of the present invention.

As shown in FIG. 3, the operational section 10 includes an OS 11, a Web browser 12, a contents display plug-in 13, framework contents 14, and displaying contents 15.

Here, the OS 11, the Web browser 12, the contents display plug-in 13, the framework contents 14, and the displaying contents 15 are realized by executing corresponding programs by the CPU 103 of the operational section 10.

The OS 11 may be Linux, or another common OS.

The Web browser 12 may be a common Web browser, and performs display control of the touch panel 311 based on HTML (HyperText Markup Language) data, or XML (Extensible Markup Language) data.

The contents display plug-in 13 is a plug-in to the Web browser 12. The contents display plug-in 13 processes contents of a specified form (for example, a form specific to the contents display plug-in 13), and thus performs display control of an operational screen image defined by the contents. For example, the contents may be data or programs for use of the display which cannot be easily expressed by HTML data or XML data, and able to provide user interfaces of a great variety of representations. Hence, when the contents display plug-in 13 is plugged into the Web browser 12, display functions of the Web browser 12 are expanded, and the operational screen displayed on the touch panel 311 can have a larger variety of representation.

The framework contents 14 form a part of the contents processed by the contents display plug-in 13, but the framework contents 14 are not actually made visible. The framework contents 14 form the contents including common contents of various kinds of the displaying contents 15 which are actually made visible, and performs loading of the displaying contents 15 to the contents display plug-in 13 and display control.

The displaying contents 15 form contents displayed on the touch panel 311 through the contents display plug-in 13 and the framework contents 14. When the displaying contents 15 are displayed, an operational image is displayed on the touch panel 311 for operating the image forming device 1.

The controller 20 includes an OS 21, a Java (a registered trademark) VM (Virtual Machine) 22, an OSGi (Open Services Gateway Initiative) framework 23, a UI controller 24, a display definition unit 25, a data management unit 26, a session management unit 27, a logic unit 28, a contents management unit 31, and a screen composition information management unit 32.

Here, the OS 21, the Java (registered trademark) VM (Virtual Machine) 22, the OSGi (Open Services Gateway Initiative) framework 23, the UI controller 24, the display definition unit 25, the data management unit 26, the session management unit 27, the logic unit 28, the contents management unit 31, and the screen composition information management unit 32 are realized by executing corresponding programs by CPU 103 of the operational section 10.

The OS 21 may be Linux, or another common OS.

The Java VM (Virtual Machine) 22 is a program interpreted and executed by an intermediate code (Java byte code) generated by a Java compiler.

The OSGi framework 23 realizes a software execution environment based on open software module technology (a standardized technology by the OSGi Alliance).

The UI controller 24 determines, depending on the conditions of the image forming device 1, the contents displayed on the contents display plug-in 13 and the framework contents 14.

Software executed on the OSGi framework 23 is embedded as a module referred to as a “bundle”. The UI controller 24 is embedded as such as bundle.

The data management unit 26 provides means for accessing data managed in the screen composition information management unit 32. In other words, access to data managed in the screen composition information management unit 32 is performed through the data management unit 26.

The session management unit 27 identifies the user who is operating the image forming device 1. User identification is performed based on the session setup in response to user authentication performed when an operation is started.

The logic unit 28 performs control for causing the image forming device 1 to function in response to input to the displaying contents 15.

The contents management unit 31 manages various kinds of the displaying contents 15 and the framework contents 14 in response to the operation screen image displayed on the touch panel 311.

The screen composition information management unit 32 manages screen composition information, namely, information of composition of the operational screen images displayed based on the displaying contents 15. Display of the displaying contents 15 through the framework contents 14 is executed based on the screen composition information.

The display definition unit 25 selects the screen composition information of the objects to be displayed depending on the conditions of the image forming device 1, for example, depending on whether the user has conducted login.

Below, further descriptions are given to the framework contents 14 and the displaying contents 15 of the operational section 10.

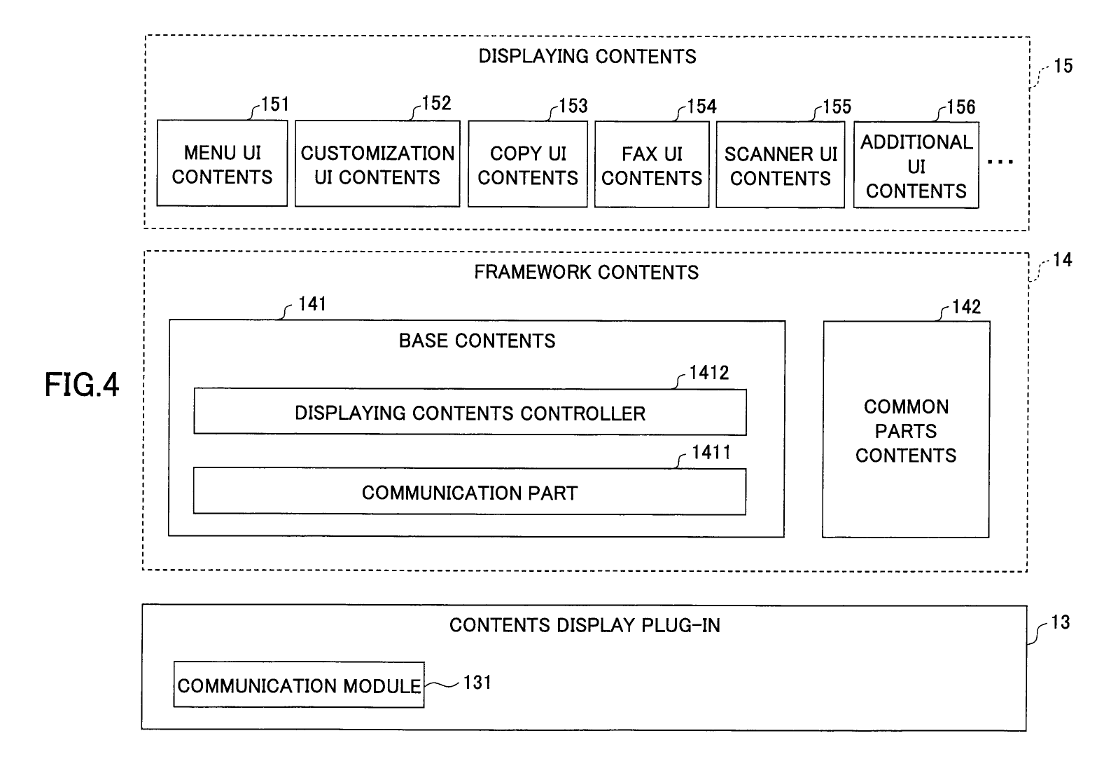

FIG. 4 is a block diagram illustrating the framework contents 14 and the displaying contents 15 of the operational section 10.

As shown in FIG. 4, the framework contents 14 include base contents 141 and common parts contents 142.

The base contents 141 form a main part of the framework contents 14, and include a communication part 1411 and a displaying contents controller 1412.

The communication part 1411 performs communications (HTTP communication) with the controller 20 through a communication module 131 of the contents display plug-in 13. Due to these communications, the screen composition information or the displaying contents 15 are acquired from the controller 20. In addition, due to these communications, events detected in the displaying contents 15 are reported to the controller 20. For example, the events may be those representing user input operations through the touch panel 311 on the operational screen image displaying the displaying contents 15.

The communication module 131 of the contents display plug-in 13 provides the communication part 1411 with an interface to HTTP communication functions of the Web browser 12.

The displaying contents controller 1412 performs display control of the displaying contents 15. Specifically, the displaying contents controller 1412 analyzes the screen composition information, and loads file groups constituting the displaying contents 15 to be displayed. The loaded files are displayed through the contents display plug-in 13.

The common parts contents 142 are contents of displaying parts (for example, buttons, background, and logo) commonly used in the displaying contents 15. For example, in the common parts contents 142, each common part corresponds to a file.

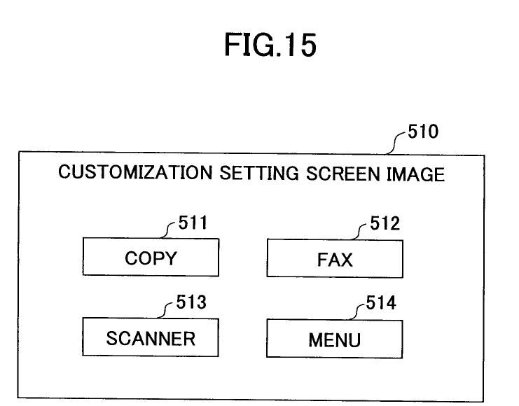

For example, as shown in FIG. 15, the displaying contents 15 may include menu UI contents 151, customization UI contents 152, copy UI contents 153, FAX UI contents 154, or scanner UI contents 155. These contents correspond to different operational screen images. For example, the menu UI contents 151 are contents for displaying a menu screen image. The customization UI contents 152 are contents for displaying a customization screen image. The copy UI contents 153, the FAX UI contents 154, and the scanner UI contents 155 are contents for displaying a copy screen image, a facsimile screen image, and a scanner screen image, respectively.

Note that the components of the displaying contents 15 can be added along with addition of new operational screen images to be displayed. For example, in FIG. 4, additional UI contents 156 are added to the displaying contents 15 for displaying a certain screen image. Further, each of the above components of the displaying contents 15 can be constituted by one or more files. In the present embodiment, the displaying contents 15 display a scanner screen image by plural file groups of data formats different from each other.

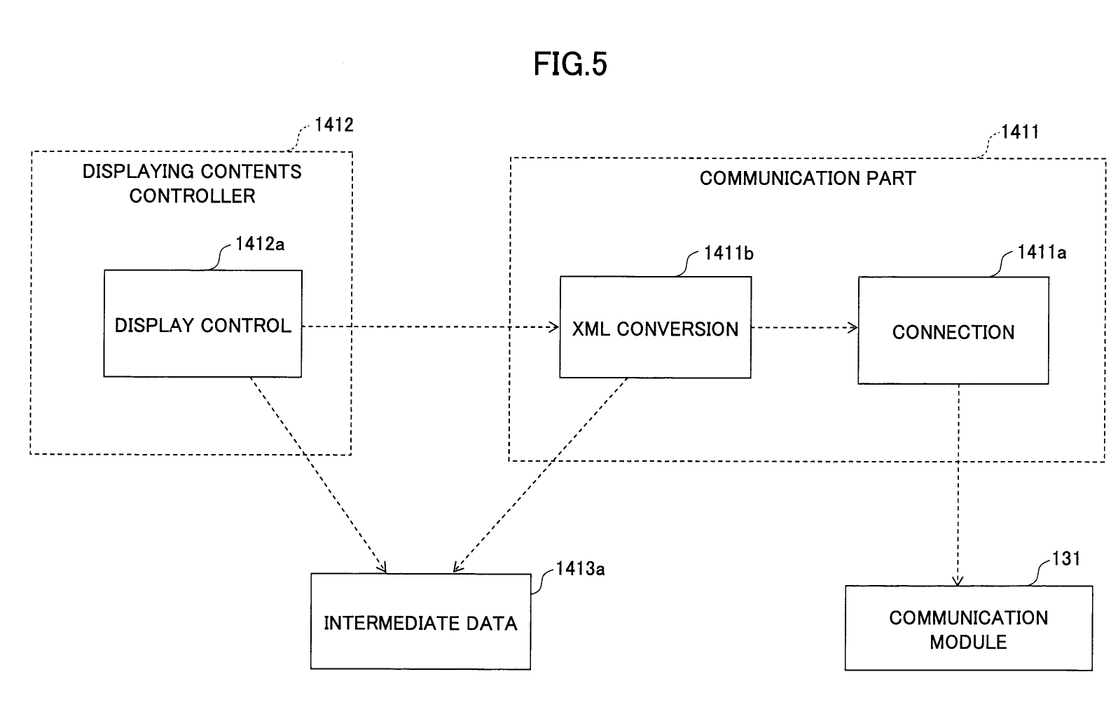

FIG. 5 is a block diagram illustrating a class diagram of the framework contents 14.

The class diagram in FIG. 5 exemplifies class groups of the framework contents 14. Specifically, the framework contents 14 may have a connection class 1411a, an XML conversion class 1411b, a display control class 1412a, and an intermediate data class 1413a.

The connection class 1411a and the XML conversion class 1411b form the communication part 1411.

The connection class 1411a is for realizing communication with the controller 20 through the communication module 131 of the Web browser 13. The connection class 1411a includes a transmission method and an event method.

The transmission method is for outputting XML data specified with parameters to the communication module 131.

The event method is for receiving response data transmitted from the communication module 131.

The display control class 1412a forms the displaying contents controller 1412. The display control class 1412a includes an event method, a screen transition method, and a display method.

The event method is for receiving data transmitted from the controller 20.

The screen transition method is for, when updating the current the displaying contents 15, acquiring the new displaying contents 15 for replacing the current the displaying contents 15.

The display method is for displaying the acquired new displaying contents 15 on the contents display plug-in 13.

The XML conversion class 1411b is for performing conversion between intermediate data, which are a kind of data interpretable by the display control class 1412a, and XML data, which are used in communication with the controller 20. Because of presence of the XML conversion class 1411b, the display control class 1412a can be installed without dependence on a data form used in communication. The XML conversion class 1411b includes an XML conversion method and an event method.

The XML conversion method converts intermediate data to XML data. The event method is for receiving the XML data transmitted from the controller 20.

The intermediate data class 1413a expresses the above intermediate data.

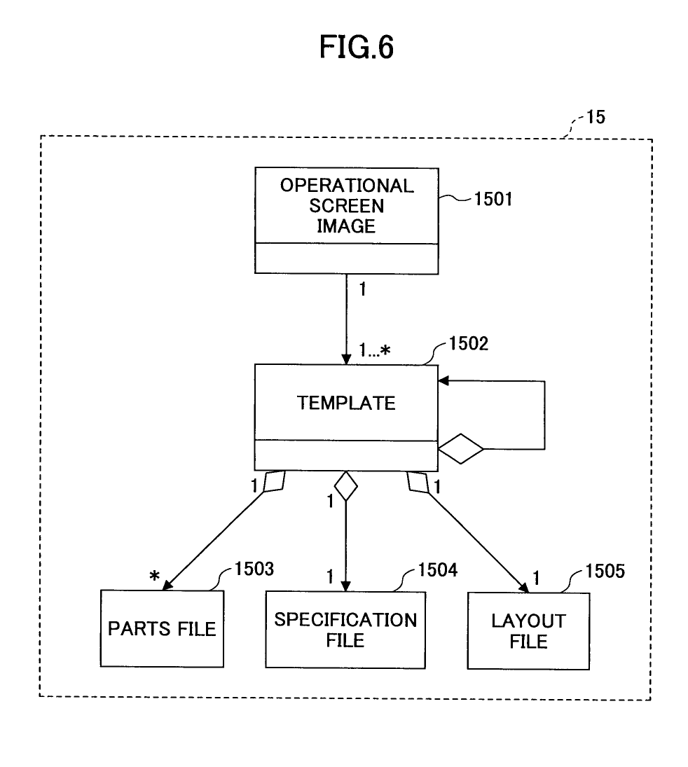

FIG. 6 is a block diagram illustrating a class diagram of the displaying contents 15 for exemplifying class groups of the displaying contents 15.

Specifically, the displaying contents 15 include an operational screen image class 1501, a template class 1502, a parts-file 1503, a specification file 1504, and a layout file 1505.

The operational screen image class 1501 is for expressing one operational screen image, and there is one instance of the operational screen image class 1501 in one displaying contents 15 (operational screen image).

The template class 1502 is for expressing a virtual part (referred to as “template”) for arranging displaying parts on the operational screen image.

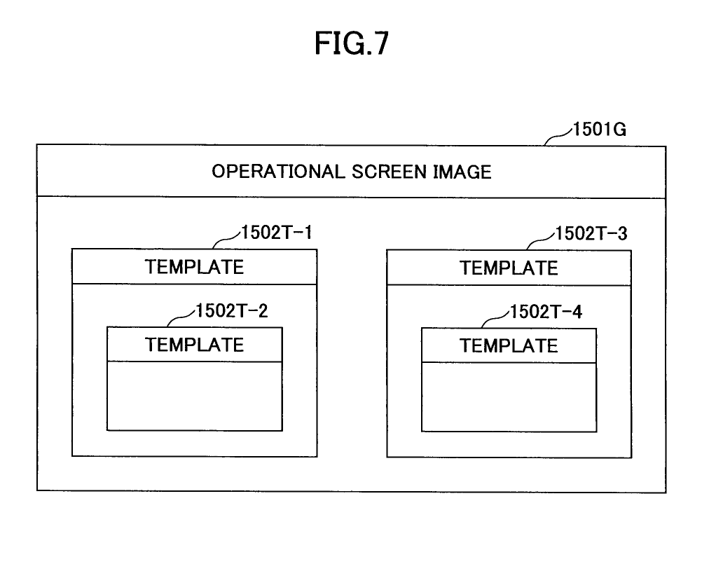

FIG. 7 is a block diagram illustrating a relationship between an operational screen image and the template. Specifically, FIG. 7 shows an operational screen image of the touch panel 311.

In FIG. 7, templates 1502T-1, 1502T-2, 1502T-3, and 1502T-4 are arranged in an operational screen image 1501G. As shown in FIG. 7, multiple templates can be arranged in one operational screen image, and each template forms a separate display area. Further, a template can be further arranged inside another template. As shown in FIG. 7, the template 1502T-2 is arranged inside the template 1502T-1, and the template 1502T-4 is arranged inside the template 1502T-3. Therefore, a term “template class 1502” is used to represent an aggregation of the templates 1502T-1, 1502T-2, 1502T-3, and 1502T-4.

Returning to FIG. 6, the parts-file 1503, the specification file 1504, and the layout file 1505 do not have a class structure, but correspond to data or files forming the above screen composition information. Each template includes multiple parts-files 1503, one specification file 1504, and one layout file 1505.

The parts-file 1503 stores data for realizing various kinds of displaying parts (for example, buttons, images, and others) to be arranged on the template. Each displaying part corresponds to a file. Depending on characteristics of the displaying parts, the displaying parts are constituted by various kinds of data for representing image data, moving picture data, text data, and GUI parts, respectively.

The specification file 1504 includes definitions of composition information of displaying parts to be arranged in the template. Below, this information is referred to as “parts composition information”.

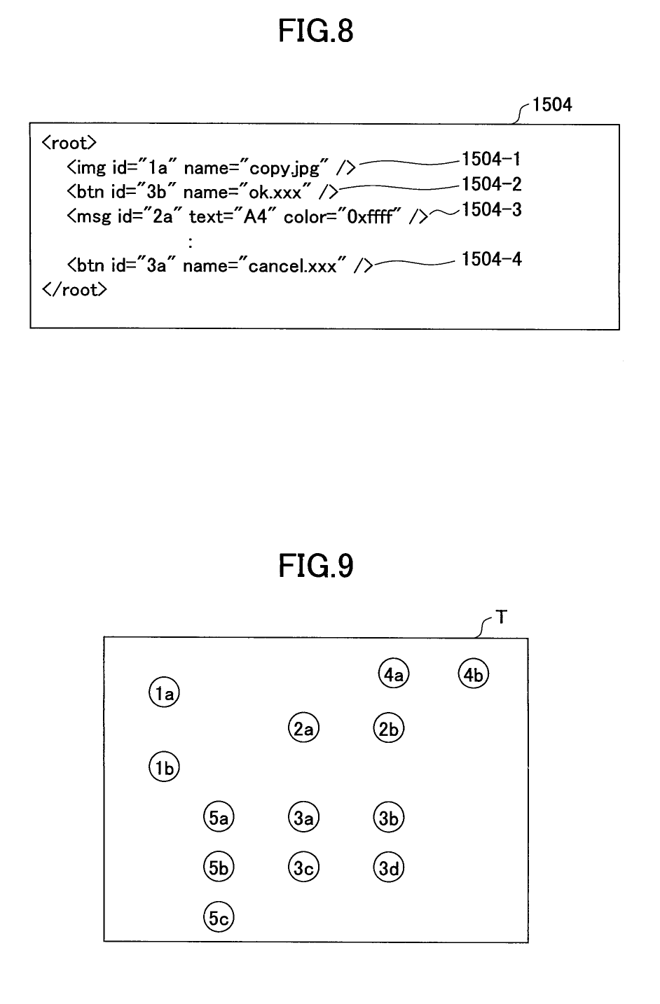

FIG. 8 is a diagram exemplifying a definition of the specification file 1504.

As illustrated in FIG. 8, the parts composition information is described by XML. It is certain that the method of defining the parts composition information is not limited to XML.

In FIG. 8, sub-elements of a root element correspond to a displaying part arranged in the template. The tag name of each element indicates the type of the displaying part associated with the element. For example, “img” indicates image data, “btn” indicates a button, and “msg” indicates a message. An “id” attribute and a “name” attribute are defined for each element. The id attribute is an ID for uniquely identifying the displaying part; the name attribute is a filename of the parts-file 1503 of the displaying part.

For example, a displaying part is defined for an element 1504-1, which has an ID of “1a” and image data of which are stored in a parts-file 1503 “copy.jpg”. In addition, a button is defined for an element 1504-2, which has an ID of “3b” and image data of which are stored in a parts-file 1503 “ok.xxx”. In this way, IDs and filenames of all displaying parts to be arranged in the template are defined in the specification file 1504.

The layout file 1505 includes definitions arrangement position information of each of the displaying parts to be arranged in the template. Below, this information is referred to as “parts arrangement information”.

FIG. 9 is a diagram schematically exemplifying a definition of the layout file 1505. It should be noted that FIG. 9 does not show a specific method of definition of the parts arrangement information, but schematically shows the parts arrangement information itself.

In FIG. 9, a rectangle T indicates a display area of a template, and symbols in circles inside the template T indicate IDs of the displaying parts defined in the specification file 1504. Further, positions of the circles indicate the arrangement positions of the displaying parts in the template T. In other words, the arrangement position of each of the displaying parts defined in the specification file 1504 is defined in the layout file 1505. For example, the definition can be made in XML form. In this case, the element may be assigned to each displaying part, and the coordinate value of the position of the displaying part may be specified as the attribute thereof.

The specification file 1504 and the layout file 1505 can be managed in the screen composition information management unit 32 by using a table as described below.

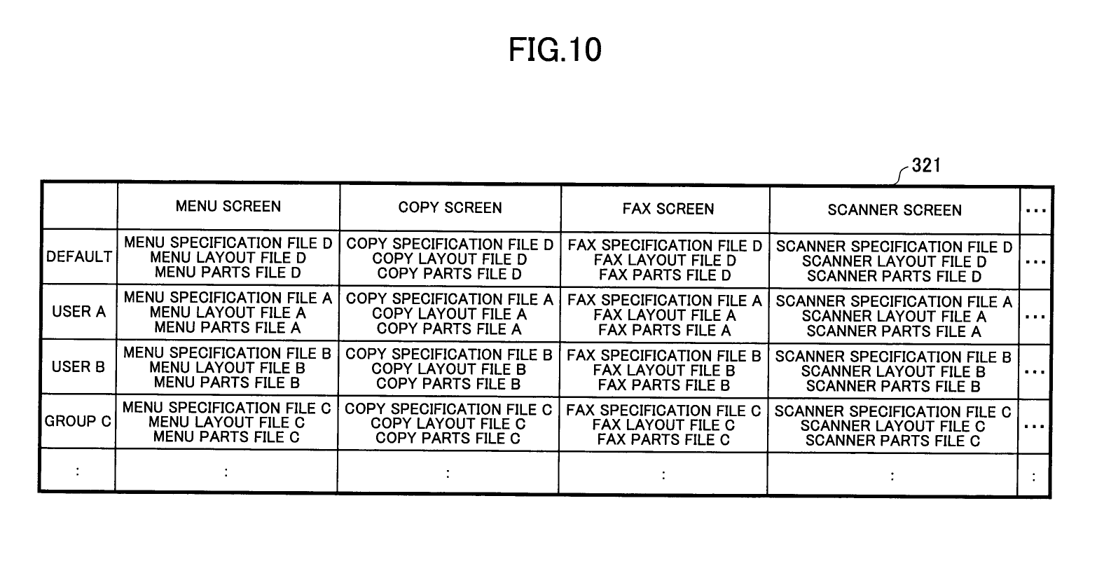

FIG. 10 is a table exemplifying a screen composition information management table.

In a screen composition information management table 321 shown in FIG. 10, the specification file 1504, the layout file 1505, and the parts-file 1503 of each operational screen image are registered for each user or each group. In doing so, the specification file 1504, the layout file 1505, and the parts-file 1503 are defined and managed in connection with each user or each group, and in connection with each operational screen image. Therefore, it is possible to display the operational screen image for each user or each group in accordance with definition in each file.

Since there are different specification files 1504, it is possible to change composition of the displaying parts displayed on the operational screen image. Further, since there are different layout files 1505, even for the same specification file 1504, it is possible to change arrangement positions of the displaying parts.

Further, since there are different parts-files 1503, even for the same specification file 1504 and the same layout file 1505, it is possible to change colors, shapes and others of the displaying parts having specified IDs.

In the screen composition information management table 321, “default” items correspond to conditions when the user does not login into the image forming device 1.

It should be noted that all of the parts-files 1503 can be managed collectively regardless of users or groups thereof. In this case, for the same ID, the same displaying part is displayed. In addition, although it is described above that one parts-file 1503 is defined in connection with each displaying part, for sake of simplicity, each of the parts-files 1503 shown in FIG. 10 corresponds to a group of parts-files 1503 defined for each user, each group, and each operational screen image.

Next, descriptions are given to the UI controller 24 and the logic unit 28 of the controller 20.

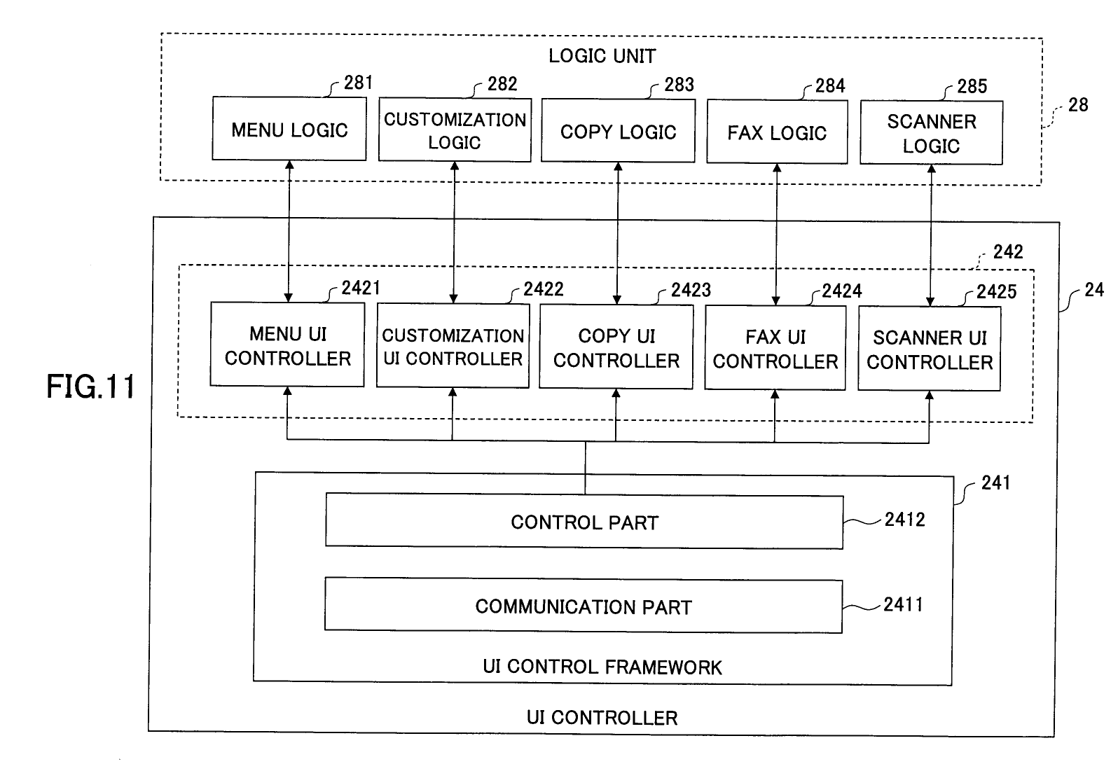

FIG. 11 is a block diagram illustrating the UI controller 24 and the logic unit 28 of the controller 20 according to the present embodiment.

As shown in FIG. 11, the UI controller 24 includes a UI control framework 241 and a UI controller 242.

The UI control framework 241 executes control processes common to the operational screen images among control processes in response to input into the various operational screen images (the displaying contents 15) displayed in the operational section 10. The UI control framework 241 includes a control part 2412 and a communication part 2411.

The communication part 2411 performs communications (HTTP communication) with the operational section 10 through a HTTP server 231 (FIG. 3) of the OSGi framework 23. Due to these communications, the screen composition information or the displaying contents 15 are provided to the operational section 10. In addition, due to these communications, events detected in the displaying contents 15 are reported to the operational section 10.

The control part 2412 performs processing in response to a request (HTTP request) transmitted from the operational section 10 through communications by the communication part 2411. For example, the control part 2412 invokes the UI controller 242 corresponding to the displaying contents 15 currently being displayed.

For example, the UI controller 242 may include a menu UI controller 2421, a customization UI controller 2422, a copy UI controller 2423, a FAX UI controller 2424, and a scanner UI controller 2425.

The UI controller 242 is installed for each of the displaying contents 15 (operational screen image) to control processing that ought to be executed in response to events generated in each of the displaying contents 15. For example, The menu UI controller 2421 corresponds to the menu UI contents 151, the customization UI controller 2422 corresponds to the customization UI contents 152, the copy UI controller 2423, the FAX UI controller 2424, and the scanner UI controller 2425 correspond to the copy UI contents 153, the FAX UI contents 154, and the scanner UI contents 155, respectively.

The logic unit 28 includes plural logics installed in connection with each of the controllers in the UI controllers 242. For example, as shown in FIG. 11, a menu logic 281, a customization logic 282, a copy logic 283, a FAX logic 284, and a scanner logic 285 are provided corresponding to the menu UI controller 2421, the customization UI controller 2422, the copy UI controller 2423, the FAX UI controller 2424, and the scanner UI controller 2425, respectively. The menu logic 281, the customization logic 282, the copy logic 283, the FAX logic 284, and the scanner logic 285 of the logic unit 28 execute controls of the hardware of the image forming device 1 in response to requests from the menu UI controller 2421, the customization UI controller 2422, the copy UI controller 2423, the FAX UI controller 2424, and the scanner UI controller 2425 of the UI controller 242, respectively.

For example, the UI controller 24 has the following class groups.

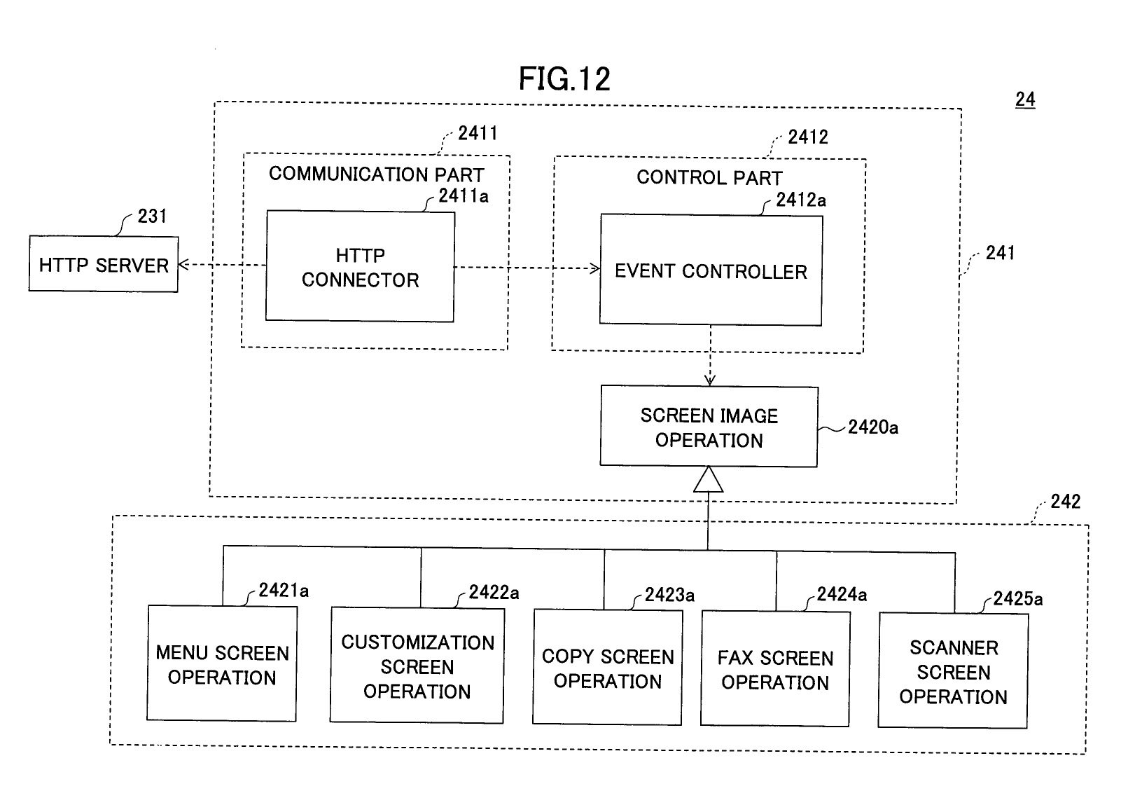

FIG. 12 is a block diagram illustrating a class diagram of the UI controller 24 for exemplifying class groups of the UI controller 24.

Specifically, the UI controller 24 includes an HTTP connect class 2411a, an event controller class 2412a, an screen image operation class 2420a, a menu screen operation class 2421a, a customization screen operation class 2422a, a copy screen operation class 2423a, a FAX screen operation class 2424a, and a scanner screen operation class 2425a.

The HTTP connect class 2411a forms the communication part 2411. The HTTP connect class 2411a includes a transmission method, which is used for transmitting data specified by parameters to the Web browser 12 through the HTTP communications (HTTP response).

The event controller class 2412a forms the control part 2412. The event controller class 2412a includes an event method, which is used for receiving an event detected in the operational section 10.

The screen image operation class 2420a is included in the UI control framework 241, and for defining operations common to the UI controllers 242, namely, the menu UI controller 2421, the customization UI controller 2422, the copy UI controller 2423, the FAX UI controller 2424, and the scanner UI controller 2425. In addition, the screen image operation class 2420a defines interfaces common to the UI controllers 242. These common interfaces (methods) may be an on Create method, an action method, or others. The on Create method defines processes that ought to be executed in response to events (on Create event) generated when the corresponding displaying contents 15 are being displayed. The action method defines processes that ought to be executed in response to events other than the on Create events, such as a button click.

The UI controllers 242 correspond to expansion formed by classes assuming the screen image operation class 2420a. In other words, classes forming the UI controllers 242, such as the menu screen operation class 2421a, the customization screen operation class 2422a, the copy screen operation class 2423a, the FAX screen operation class 2424a, and the scanner screen operation class 2425a, can be installed by differential programming with respect to the screen image operation class 2420a. Each sub-class includes definitions of operations specific to the corresponding operational screen images in the interfaces defined by the screen image operation class 2420a, such as the on Create method and the action method.

Since the UI controllers 242 have such a class structure, when a new operational screen image (displaying contents 15) is added, it is sufficient to install a class corresponding to the new operational screen image as a sub-class of the screen image operation class 2420a. If necessary, a logic unit 28 corresponding to the new operational screen image may also be installed.

Below, operations of the image forming device 1 are described.

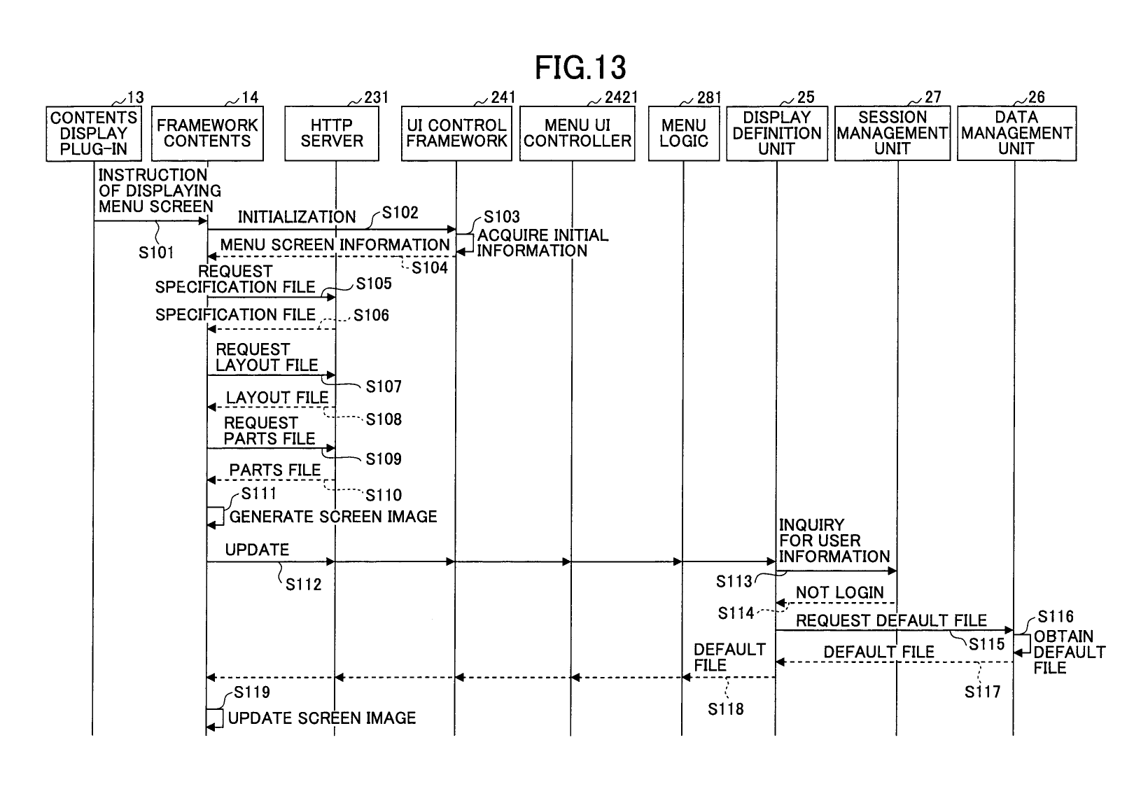

FIG. 13 is a sequence diagram illustrating a display process of the operational screen image when the user does not login.

When the user does not login, instead of an operational screen image specific to the user, a default operational screen image common to all users is displayed on the touch panel 311.

As shown in FIG. 13, in step S101, when the image forming device 1 is powered on, and an operational screen image is to be displayed on the touch panel 311, the contents display plug-in 13 instructs the framework contents 14 to display a menu screen image as an initializing screen image.

In step S102, in response to the instruction of displaying the menu screen, the framework contents 14 request, via the HTTP communication, the UI control framework 241 to perform initialization. The HTTP communication by the framework contents 14 is performed through the communication module 131 of the contents display plug-in 13, the Web browser 12, and others. For the purpose of simplicity, detailed description related to this is omitted.

In step S103, in response to the request of initialization, the UI control framework 241 acquires position information of the specification file 1504, and the layout file 1505 corresponding to a “fixed portion” of the menu screen from a specified memory region. For example, the position information may be the URL (Uniform Resource Locator) of the specification file 1504, and the layout file 1505.

In step S104, the UI control framework 241 returns the acquired position information (menu screen information) to the framework contents 14.

Here, the “fixed portion” of the menu screen image means the portion of the menu screen that cannot be customized or does not change depending on users. Therefore, in the specification file 1504 and the layout file 1505 corresponding to the fixed portion of the menu screen image, conditions of the fixed portion are defined, but conditions of the variable portion, which means the portion of the menu screen that can be customized or changed depending on users, has not been defined and needs to be defined and inserted into the specification file 1504 and the layout file 1505 in the display process.

In step S105, the framework contents 14 request the HTTP server 231 to provide the specification file 1504 of the fixed portion of the menu screen image based on the URL of the specification file 1504 included in the returned menu screen information.

In step S106, the framework contents 14 acquire the specification file 1504 of the fixed portion of the menu screen image from the HTTP server 231.

In step S107, the framework contents 14 request the HTTP server 231 to provide the layout file 1505 of the fixed portion of the menu screen image based on the URL of the layout file 1505 included in the returned menu screen information.

In step S108, the framework contents 14 acquire the layout file 1505 of the fixed portion of the menu screen image from the HTTP server 231.

In step S109, the framework contents 14 request the HTTP server 231 to provide the parts-file 1503, a filename of which is written (defined) in the specification file 1504 of the menu screen image.

In step S110, the framework contents 14 acquire the parts-file 1503 from the HTTP server 231.

In step S111, the displaying contents controller 1412 of the framework contents 14 arranges the displaying parts stored in the acquired parts-file 1503 at positions defined by the acquired layout file 1505 to generate the menu screen image, and to display the menu screen image on the touch panel 311.

However, at this stage, only the fixed portion of the menu screen image is displayed, and the variable portion of the menu screen image has not displayed, yet.

In step S112, in order to insert the definition of the variable portion, the framework contents 14 transmit signals to the HTTP server 231 to request the HTTP server 231 to update conditions of the current screen image (here, it is the menu screen image). The update request is reported to the display definition unit 25 via the UI control framework 241, the menu UI controller 2421, and the menu logic 281.

In step S113, the display definition unit 25 queries the session management unit 27 of the user who has completed login.

In step S114, since there is no user who has completed login at this stage, the session management unit 27 makes a response that there is no user who completed login.

In step S115, the display definition unit 25 requests the data management unit 26 to provide the specification file 1504 and the layout file 1505 corresponding to the variable portion of the default menu screen image. Below, the specification file 1504 and the layout file 1505 corresponding to the variable portion of the default menu screen image are referred to as “default files”.

In step S116, the data management unit 26 determines the default files based on the screen composition information management table 321, and acquires the default files.

In step S117, the data management unit 26 returns the results to the display definition unit 25.

In step S118, the default files are returned from the display definition unit 25 to the framework contents 14 through the menu logic 281, the menu UI controller 2421, the UI control framework 241, and the HTTP server 231.

In step S119, the framework contents 14 displays the variable portion of the menu screen image based on the returned default files. In this case, when necessary, the framework contents 14 acquire, from the HTTP server 231, the parts-file 1503 (namely, a menu parts-file D) managed for the default menu screen image, and use the acquired parts-file as the parts-file 1503 corresponding to the variable portion.

In this way, the complete default menu screen image is displayed on the touch panel 311.

Below, descriptions are given to operations of the image forming device 1 when the user competed login.

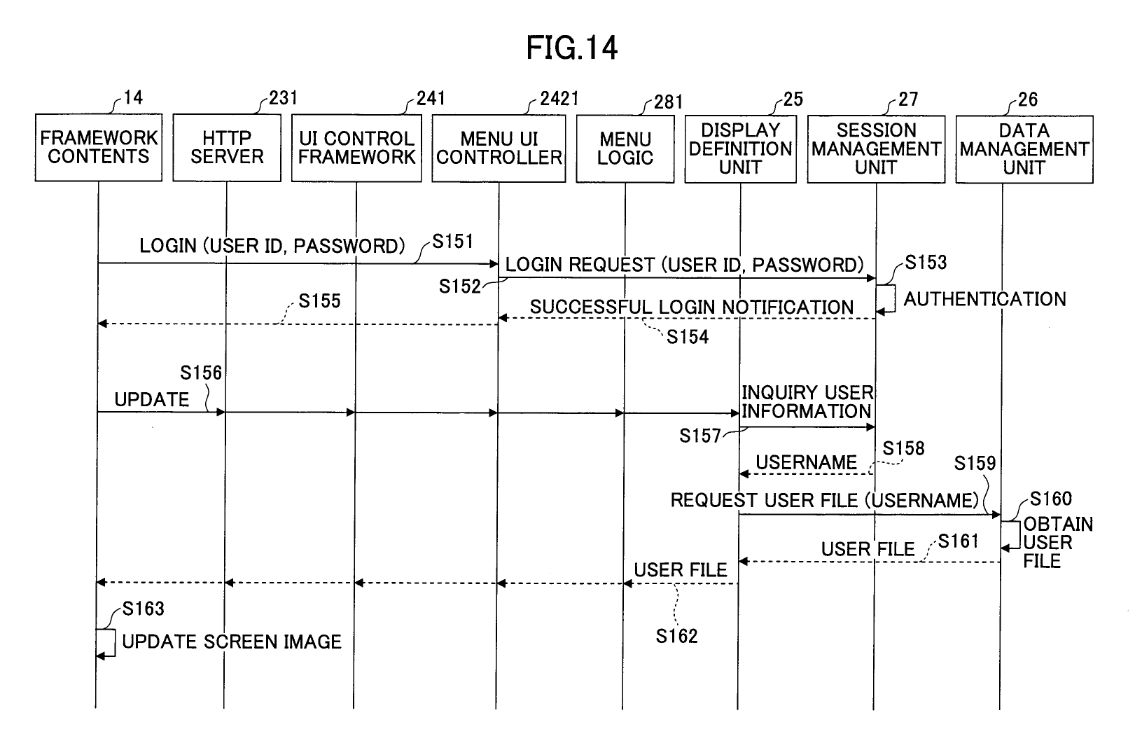

FIG. 14 is a sequence diagram illustrating a display process of the operational screen image when the user completed login.

As shown in FIG. 14, in step S151, when a user ID and a password are input the menu screen image displayed on the touch panel 311 and a login button is pressed, the framework contents 14 transmit a login request of the user to the menu UI controller 2421 through HTTP communications. For example, the login request includes the input user ID and password.

In step S152, the menu UI controller 2421 specifies the input user ID and password included in the login request, and requests the session management unit 27 to allow the user to login.

In step S153, the session management unit 27 authenticates the user based on the user ID and password.

In step S154, once the user authentication succeeds, the session management unit 27 opens a session for the authenticated user (below, referred to as “current user”), and sends a response to the menu UI controller 2421 indicating success of login.

In step S155, the menu UI controller 2421 sends a HTTP response to the framework contents 14 indicating the login success.

In step S156, in response to the login success, the framework contents 14 transmit a request to the HTTP server 231 for updating conditions of the current screen image so as to change the menu screen image currently being displayed to the menu screen image associated with the current user, in other words, to customize the menu screen image for the current user. The update request is reported to the display definition unit 25 via the UI control framework 241, the menu UI controller 2421, and the menu logic 281.

In step S157, the display definition unit 25 queries the session management unit 27 of the user who has completed login.

In step S158, based on the currently opened session, the session management unit 27 identifies the current user, and returns information of the current user (for example, a username) to the display definition unit 25.

In step S159, the display definition unit 25 specifies the username of the current user, and requests the data management unit 26 to provide the specification file 1504 and the layout file 1505 corresponding to the current user. Below, the specification file 1504 and the layout file 1505 corresponding to the current user are referred to as “user files”.

In step S160, the data management unit 26 determines the user files based on the screen composition information management table 321, and acquires the user files.

In step S161, the data management unit 26 returns the acquired user files to the display definition unit 25.

In step S162, the user files are returned from the display definition unit 25 to the framework contents 14 through the menu logic 281, the menu UI controller 2421, the UI control framework 241, and the HTTP server 231.

In step S163, the framework contents 14 update the variable portion of the menu screen image based on the returned user files. In this case, if necessary, the framework contents 14 acquire, from the HTTP server 231, the parts-file 1503 managed for the menu screen image of the current user.

In this way, the menu screen image customized for the current user is displayed on the touch panel 311.

When the default menu screen image and the menu screen image of the current user differ from each only in composition of the displaying parts, in step S161 and S162, it is sufficient to transfer only the specification file 1504 corresponding to the current user from the data management unit 26 to the framework contents 14. In this case, the framework contents 14 change the displaying parts on the menu screen based on reception of only the returned specification file 1504.

When the default menu screen image and the menu screen image of the current user differ from each only in arrangement positions of the displaying parts, in step S161 and S162, it is sufficient to transfer only the layout file 1505 corresponding to the current user from the data management unit 26 to the framework contents 14. In this case, the framework contents 14 change arrangement positions of the displaying parts on the menu screen based on reception of only the returned layout file 1505.

When the default menu screen image and the menu screen image of the current user differ from each only in the displaying parts themselves, in step S161 and S162, it is sufficient to transfer only the parts-file 1503 corresponding to the current user from the data management unit 26 to the framework contents 14. In this case, upon reception of only the returned parts-file 1503, the framework contents 14 changes display conditions (color, shape, type, and others) of the displaying parts on the menu screen based on the returned parts-file 1503.

In this way, in the present embodiment, the framework contents 14 are able to dynamically change the display mode of a part of the operational screen image (conditions of the displaying parts, layout, or the displaying parts themselves) based on at least one of the parts-file 1503, the layout file 1505, and the specification file 1504. This is greatly different from techniques in the related art for displaying HTML data, in which techniques contents of the operational screen image are defined by XML data, the layout of the operational screen image is defined by XSLT (XML Stylesheet Language Transformations) data, and the HTML data are produced based on the XML data and the XSLT data. Namely, in the related art, even when it is desired to change only a part of the operational screen image, it is necessary to generate all the HTML data again.

Next, customization of the operational screen image is described.

In the present embodiment, customization of the operational screen image is performed by operations on a customization setting screen image.

FIG. 15 is a block diagram exemplifying a customization setting screen image according to the present embodiment.

As shown in FIG. 15, a customization setting screen image 510 includes a copy button 511, a FAX button 512, a scanner button 513, and a menu button 514. The copy button 511, the FAX button 512, the scanner button 513, and the menu button 514 are for displaying customization screen images for customizing a copy operational screen image, a FAX operational screen image, a scanner operational screen image, and a menu operational screen image, respectively. For example, when the copy button 511 is pressed, a customization screen image for customizing the copy screen image is displayed on the touch panel 311. Hereinafter, the customization screen image for customizing the copy screen image is referred to as “copy UI setting screen image”.

Below, customization of the copy screen image is used as an example to explain the customization process.

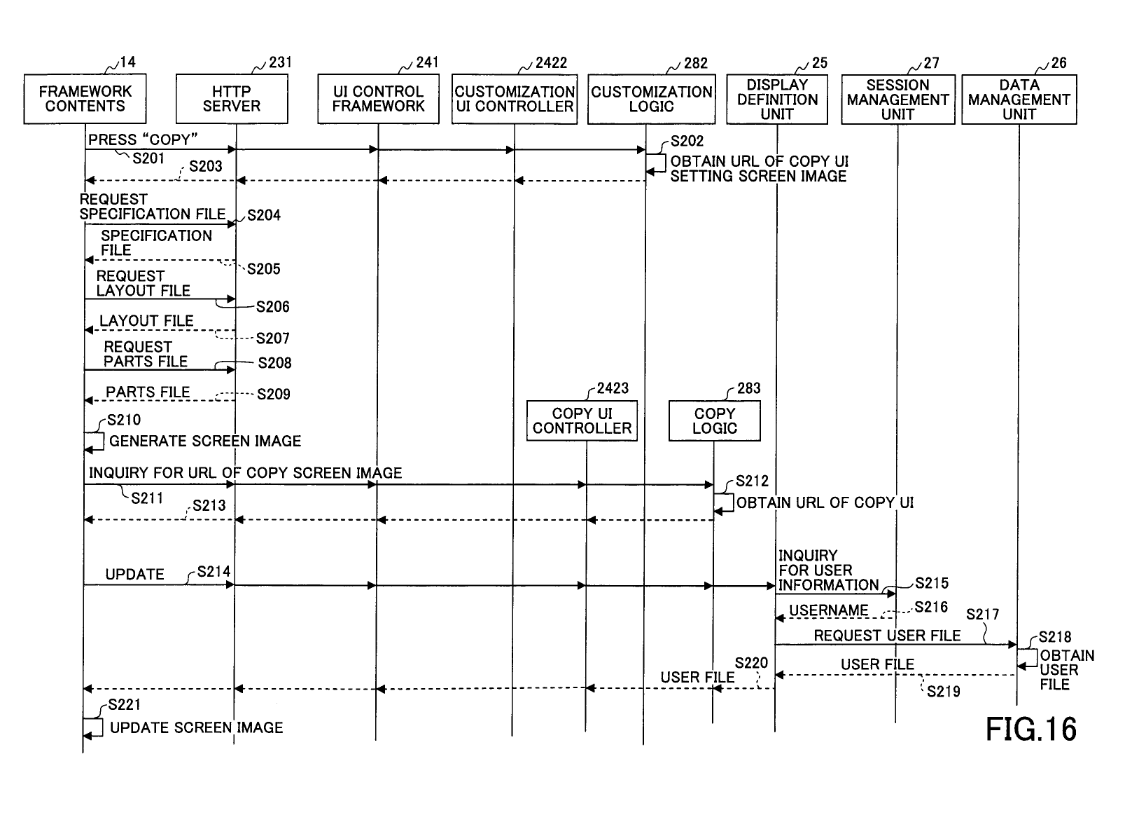

FIG. 16 is a sequence diagram illustrating a display process of a copy UI setting screen image.

As shown in FIG. 16, in step S201, on the customization setting screen image 510 shown in FIG. 15 is displayed on the touch panel 311, when the copy button 511 is selected (pressed), the framework contents 14 detects selection of the copy button 511, and notifies the HTTP server 231 that the copy button 511 is selected. Further, the selection of the copy button 511 is reported to the customization logic 282 through the UI control framework 241 and the customization UI controller 2422.

In step S202, the customization logic 282 acquires information including the URL of the customization setting screen image corresponding to the copy button 511, namely, the copy UI setting screen image from a specified memory region. Below, the information including the URL of the customization setting screen image is referred to as “URL information”.

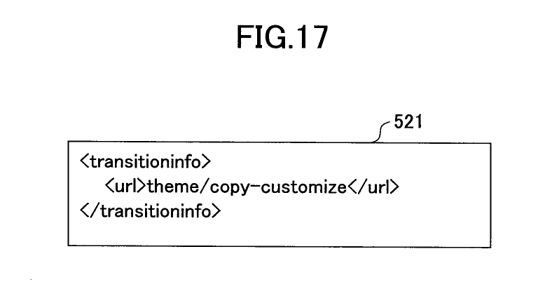

FIG. 17 is a diagram exemplifying the URL information of the copy UI setting screen image. In FIG. 17, as an example, the URL information is written in an XML form.

In the URL information 521 shown in FIG. 17, the value (“theme/copy-customize”) of a url element, which is defined as a sub-element of an element “transitioninfo”, corresponds to the URL of the copy UI setting screen image. Note that this URL corresponds to the URL of the fixed portion of the copy UI setting screen image.

Returning to FIG. 16, in step S203, the URL information 521 is returned to the framework contents 14 through the customization logic 282, the customization UI controller 2422, the UI control framework 241, and the HTTP server 231.

In steps S204 through S207, the framework contents 14, which receive the URL information 521, acquire, from the HTTP server 231, the specification file 1504 and the layout file 1505 corresponding to the fixed portion of the copy UI setting screen image based on the URL included in the URL information 521.

In step S208 and S209, the framework contents 14 acquire, from the HTTP server 231, the parts-file 1503, a filename of which is written in the acquired specification file 1504.

In step S210, the framework contents 14 arrange the displaying parts stored in the acquired parts-file 1503 at positions defined in the acquired layout file 1505, thereby generating the fixed portion of the copy UI setting screen image, and displays the fixed portion of the copy UI setting screen image on the touch panel 311.

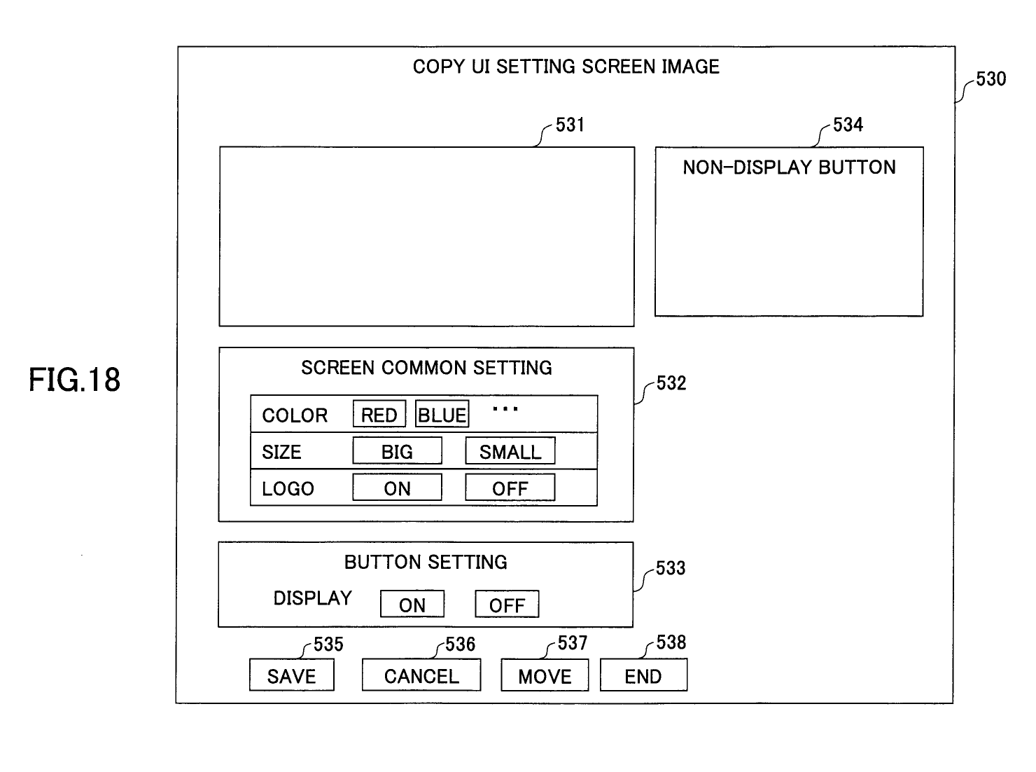

FIG. 18 is a block diagram exemplifying the fixed portion of the copy UI setting screen image.

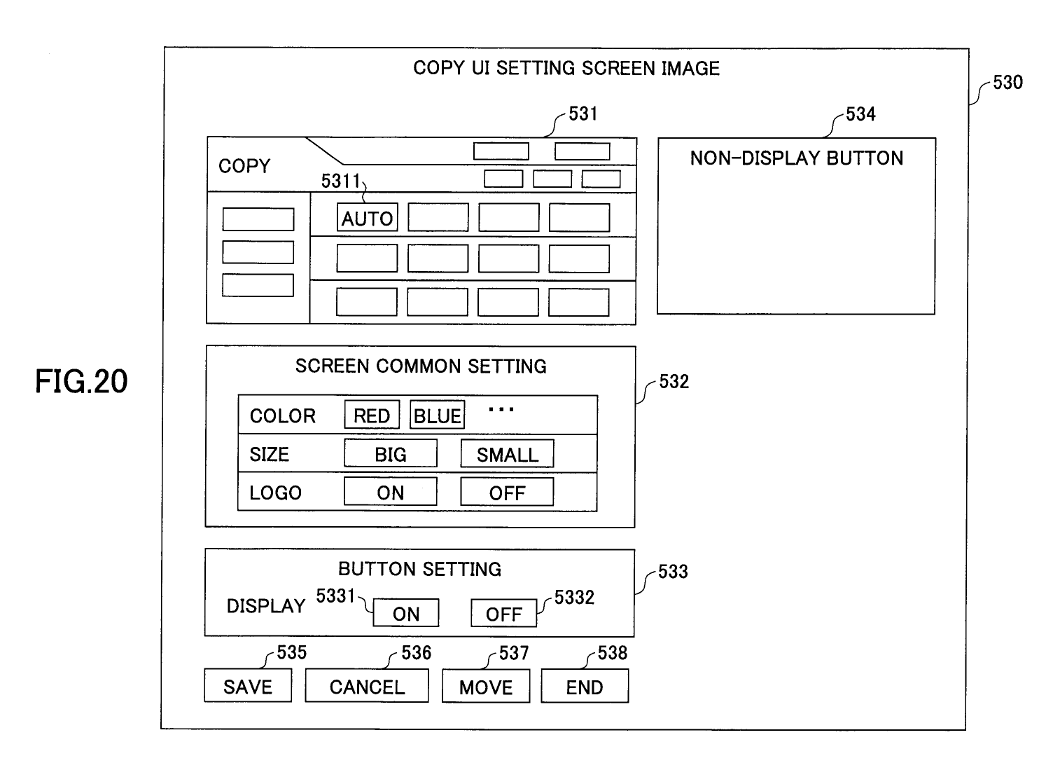

As shown in FIG. 18, a copy UI setting screen image 530 includes a copy screen image display area 531, a screen common setting area 532, a button setting area 533, a non-display button display area 534, a save button 535, a cancel button 536, a move button 537, and an end button 538 (see FIG. 20). Among the above, the components other than the copy screen image display area 531 belong to the fixed portion. In other words, in FIG. 18, except for the copy screen image display area 531, the fixed portion is displayed completely.

The copy screen image display area 531 is for displaying the current setting conditions (customization conditions) of the copy screen image. The customization conditions of the copy screen image depend on users. Thus, the copy screen image display area 531 belongs to the variable portion.

Returning to FIG. 16, in step S211, in order to display the variable portion of the copy UI setting screen image 530, that is, the copy screen image, the framework contents 14 transmit signals to query the HTTP server 231 about the URL information of the copy screen image. This inquiry is reported to the copy logic 283 through the HTTP server 231, the UI control framework 241, the customization UI controller 2422, and the copy UI controller 2423.

In step S212, the copy logic 283 acquires the URL information, that is, the information including the URL of the copy screen image, from a specified memory region.

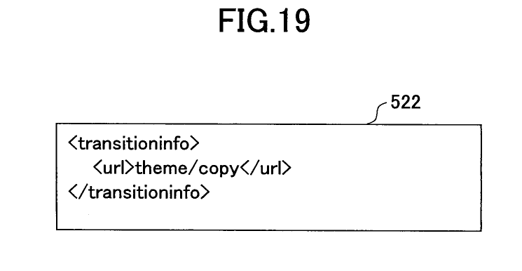

FIG. 19 is a diagram exemplifying the URL information of the copy screen image. In FIG. 19, as an example, the URL information is written in the XML form.

In the URL information 522 shown in FIG. 19, the value (“theme/copy”) of a url element, which is defined as a sub-element of an element “transitioninfo”, corresponds to the URL of the copy screen image.

Returning to FIG. 16, in step S213, the URL information 522 is returned to the framework contents 14 through the copy logic 283, the copy UI controller 2423, the UI control framework 241, and the HTTP server 231.

In step S214, in order to update the display conditions of the copy UI setting screen image 530 (that is, to display the copy screen image on the copy screen image display area 531), the framework contents 14 specify the URL included in the URL information 522, and transmit a request of updating the copy UI setting screen image 530 to the HTTP server 231. This update request is reported to the display definition unit 25 via the UI control framework 241, the copy UI controller 2423, and the copy logic 283.

In step S215, the display definition unit 25 queries the session management unit 27 of the user who has completed login.

In step S216, based on the currently opened session, the session management unit 27 identifies the current user, and returns information of the current user (for example, a username) to the display definition unit 25.

In step S217, the display definition unit 25 specifies the username of the current user, and requests the data management unit 26 to provide the specification file 1504 and the layout file 1505 corresponding to the current user (that is, user files).

In step S218, the data management unit 26 determines the user files based on the screen composition information management table 321, and acquires the user files.

In step S219, the data management unit 26 returns the acquired user files to the display definition unit 25.

In step S220, the user files are returned from the display definition unit 25 to the framework contents 14 through the copy logic 283, the copy UI controller 2423, the UI control framework 241, and the HTTP server 231.

In step S221, the framework contents 14 update the variable portion (the copy screen image display area 531) of the copy UI setting screen image 530 based on the returned user files, that is, display the copy screen image on the copy screen image display area 531. In this case, if necessary, the framework contents 14 acquire a new parts-file 1503 from the HTTP server 231.

In this way, a complete copy UI setting screen image is displayed on the touch panel 311.

FIG. 20 is a block diagram exemplifying a complete copy UI setting screen image.

As shown in FIG. 20, the copy screen image is displayed in the copy UI setting screen image 530. Customization (namely, edition) of the copy screen image is performed by user operations on the copy UI setting screen image in this state.

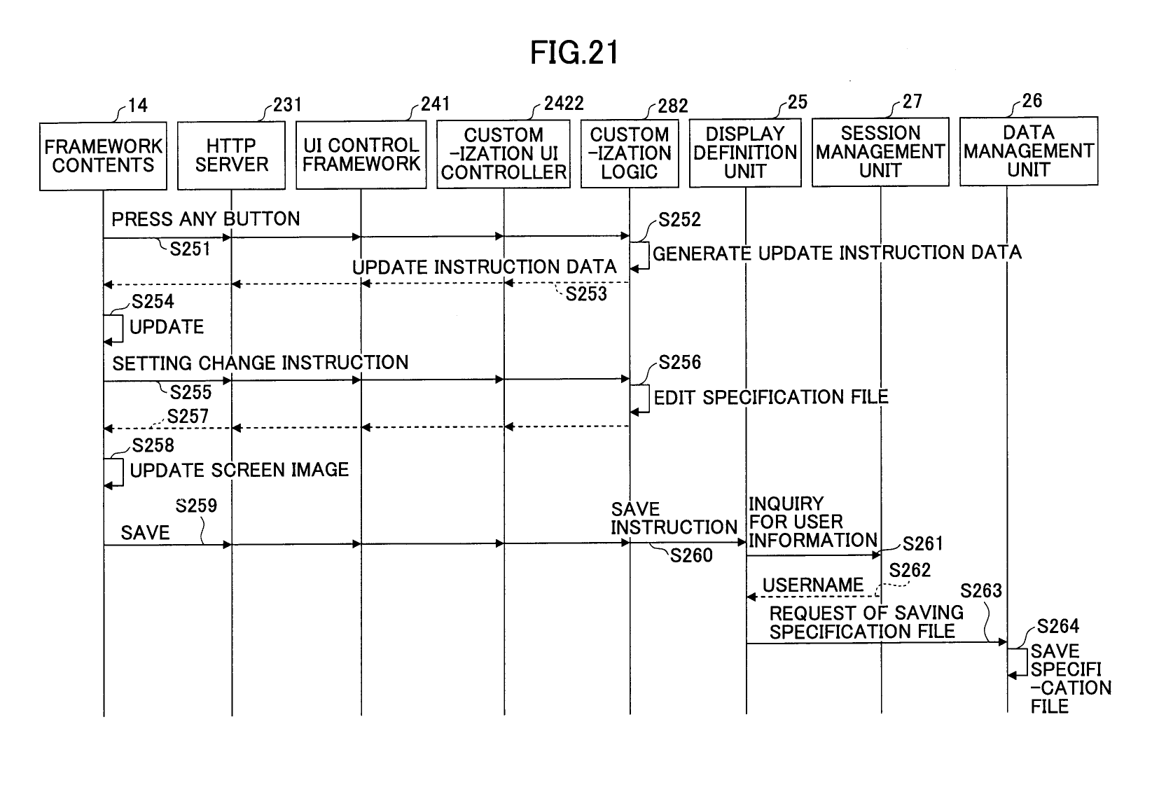

FIG. 21 is a sequence diagram illustrating a customization process of the copy screen image.

As shown in FIG. 21, in step S251, on the copy screen image displayed in the copy screen image display area 531 of the copy UI setting screen image 530, when any button displayed in the copy screen image (for example, an AUTO button 5311) is selected (pressed), the framework contents 14 detect that the AUTO button 5311 is pressed, and transmit data indicating that the AUTO button 5311 is pressed to the HTTP server 231. This kind of data is referred to as “event notification data”.

Further, the event notification data are reported to the customization logic 282 through the UI control framework 241 and the customization UI controller 2422.

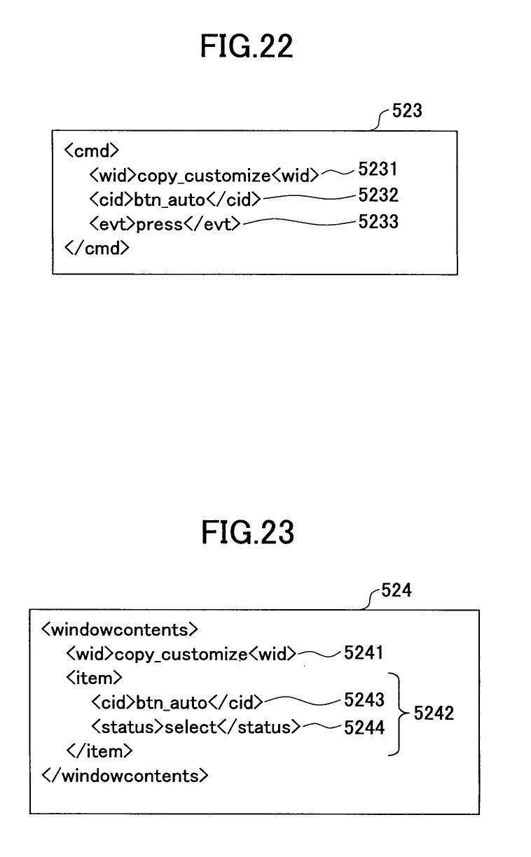

FIG. 22 is a diagram exemplifying the event notification data. In FIG. 22, as an example, the event notification data are written in the XML form.

In the event notification data 523 shown in FIG. 22, the value (“copy-customize”) of a wid element 5231 indicates an ID of the operational screen image in which the event is generated. Here, specifically, “copy-customize” is the ID of the copy UI setting screen image 530. The value (“btn-auto”) of a cid element 5232 indicates an ID of a displaying part involved in the event. Here, specifically, “btn-auto” is an ID of the AUTO button 5311. The value (“press”) of an evt element 5233 indicates the type of an event. Here, specifically, “press” is an identifier indicating a press event. That is, the event of pressing the AUTO button 5311 is described in the event notification data 523. This event notification data 523 are reported to the customization logic 282 through the UI control framework 241 and the customization UI controller 2422.

Returning to FIG. 21, in step S252, the customization logic 282 identifies the event of pressing the AUTO button 5311 based on the event notification data 523, and in response to the event notification data 523, generates data indicating an updating instruction of the display condition of the screen image in connection to the selection of the AUTO button 5311. Below, the data indicating an updating instruction of the display condition of the screen image are referred to as “condition updating instruction data”.

FIG. 23 is a diagram exemplifying the condition updating instruction data. In FIG. 23, as an example, the condition updating instruction data are written in the XML form.

In the condition updating instruction data 524 shown in FIG. 23, the value (“copy-customize”) of a wid element 5241 indicates an ID of the operational screen image to be updated. Here, specifically, “copy-customize” is the ID of the copy UI setting screen image 530.

The condition updating instruction data 524 include a number of items equaling the number of the displaying parts to be updated. An item element includes a cid sub-element and a status sub-element.

The value of the cid sub-element indicates an ID of a displaying part to be updated. The status sub-element indicates the conditions after updating.

In the condition updating instruction data 524 shown in FIG. 23, an item element 5242 includes a cid sub-element 5243 and a status sub-element 5244. The value of the cid sub-element 5243 is “btn-auto”, indicating the AUTO button 5311. The value of the status sub-element is “select”.

That is, the condition updating instruction data 524 instructs to select the AUTO button 5311.

Returning to FIG. 21, in step S253, the condition updating instruction data 524 are returned to the framework contents 14 through the customization logic 282, the customization UI controller 2422, the UI control framework 241, and the HTTP server 231.

In step S254, the framework contents 14, which receive the condition updating instruction data 524, update the display conditions of the copy UI setting screen image 530 based on the received condition updating instruction data 524. That is, the AUTO button 5311 is selected, in other words, the AUTO button 5311 is set to be the object to be edited.

Next, a user inputs an instruction to change the display setting of the copy screen image in the copy UI setting screen image 530. For example, in the screen common setting area 532, concerning the whole copy screen image, the display color, size, and logo arrangement can be set. In the button setting area 533, display or non-display conditions can be set. For example, when an OFF button 5332 is pressed, the button which is the object to be edited is set to not be displayed, and this button is moved to the non-display button display area 534. When a button displayed in the non-display button display area 534 is selected and a display button 5331 is pressed, the button returns to the previous display position, and becomes a display object.

Below, assume in the button setting area 533, the OFF button 5332 is pressed.

In step S255, when the framework contents 14 detect that the OFF button 5332 is pressed, the framework contents 14 transmit data indicating that the OFF button 5332 is pressed to the HTTP server 231. These event notification data are reported to the customization logic 282 through the UI control framework 241 and the customization UI controller 2422.

In step S256, the customization logic 282 identifies the event of pressing the OFF button 5332 based on the event notification data, and in response to the event notification data, stores in the memory a set of data instructing that the AUTO button 5311 be set not to display.

In step S257, in the copy UI setting screen image 530, the customization logic 282 generates condition updating instruction data indicating to move the AUTO button 5311 to the non-display button display area 534. These condition updating instruction data are returned to the framework contents 14 through the customization logic 282, the customization UI controller 2422, the UI control framework 241, and the HTTP server 231.

In step S258, based on the received condition updating instruction data, the framework contents 14 move the AUTO button 5311 to the non-display button display area 534, that is, the display position of the AUTO button 5311 is moved to the non-display button display area 534.

Afterward, the user can continue to change settings of other buttons or the whole screen image in the copy UI setting screen image 530. The customization logic 282 stores the input data related to the setting changes in a memory.

In step S259, after the setting change is completed, and when the save button 535 is pressed, the framework contents 14 transmit the event notification data indicating that the save button 535 is pressed to the HTTP server 231. The event notification data are reported to the customization logic 282 through the UI control framework 241 and the customization UI controller 2422.

In step S260, the customization logic 282 identifies that the save button 535 is pressed based on the event notification data, and instructs the display definition unit 25 to store the condition updating instruction data temporarily held in the memory so far.

In step S261, the display definition unit 25 queries the session management unit 27 of the user who completes login.

In step S262, based on the currently opened session, the session management unit 27 identifies the current user, and returns information of the current user (for example, a username) to the display definition unit 25.

In step S263, the display definition unit 25 specifies the username of the current user, and requests the data management unit 26 to store the setting changes to the specification file 1504 (if necessary, the layout file 1505 as well) of the copy screen image corresponding to the current user, thereby reflecting the setting changes.

In step S264, the data management unit 26 determines the specification file 1504 of the copy screen image corresponding to the current user based on the screen composition information management table 321, and stores the setting changes of the specification file 1504. Here, the AUTO button 5311 is set to be non-display.

As a result, for example, the specification file 1504 of the copy screen image of the current user is updated and stored as indicated below.

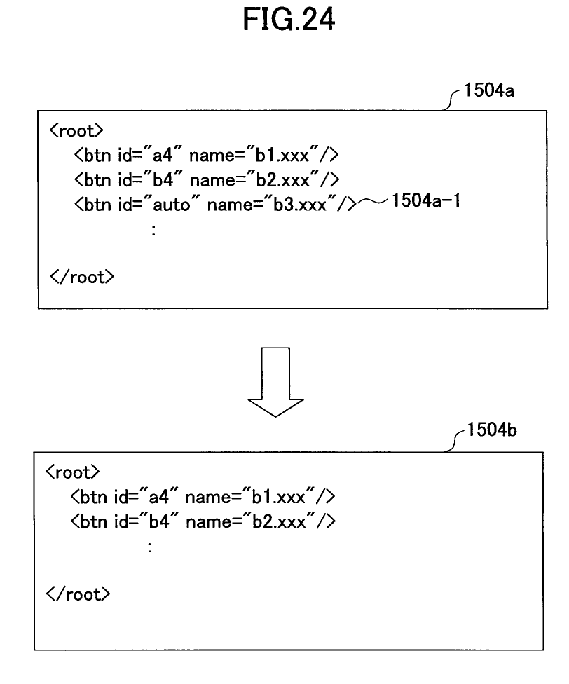

FIG. 24 is a diagram exemplifying updating of the specification file 1504.

In FIG. 24, a specification file 1504a represents the specification file 1504 prior to updating, and a specification file 1504b represents the specification file 1504 after updating.

In the specification file 1504a, an element 1504a-1 corresponds to the definition of the AUTO button 5311. When the AUTO button 5311 is set to be non-display, as shown in the specification file 1504b, the element 1504a-1 is deleted. Then, when the user logins, the copy screen image is generated based on the specification file 1504b. In the specification file 1504b, since there is no definition of the AUTO button 5311, the AUTO button 5311 is not displayed in the copy screen image.

In the above, change of the current displaying parts is exemplified, but the present embodiment is not limited to this. For example, when changing the layout of the displaying parts, the instruction of changing the arrangement positions of the displaying parts can be inputted by drag and drop in the copy screen image display area 531. Alternatively, the displaying parts, the arrangement positions of which are to be changed, can be selected in the copy screen image display area 531, and then the move button 537 is pressed to display choices of destinations of the displaying parts, that is, the places to which the displaying parts are to be moved.

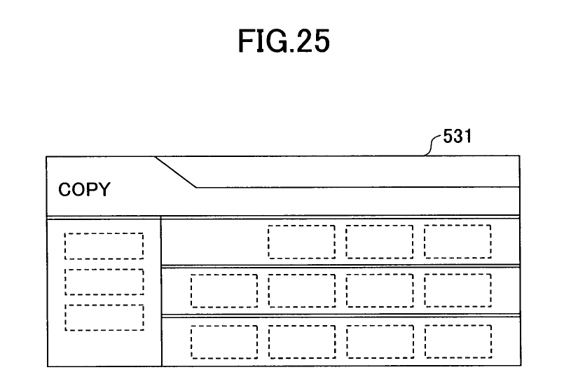

FIG. 25 is a diagram exemplifying the choices of destinations of the displaying parts. Note that only the copy screen image display area 531 of the copy UI setting screen image 530 is extracted and illustrated in FIG. 25.

In FIG. 25, positions able to be specified as destinations of the AUTO button 5311 are represented by dashed-line rectangles. When the user selects one of the rectangles, the selected rectangle becomes the destination of the AUTO button 5311, that is, the AUTO button 5311 is moved to this rectangle.

When it is specified that the arrangement positions of the displaying parts are to be changed, it is sufficient that IDs of the displaying parts to be moved and identification information for identifying the destination are reported to the customization logic 282. The customization logic 282 changes (updates) the layout file 1505 based on the received information. Alternatively, instead of the layout file 1505, the customization logic 282 may change (updates) the specification file 1504.

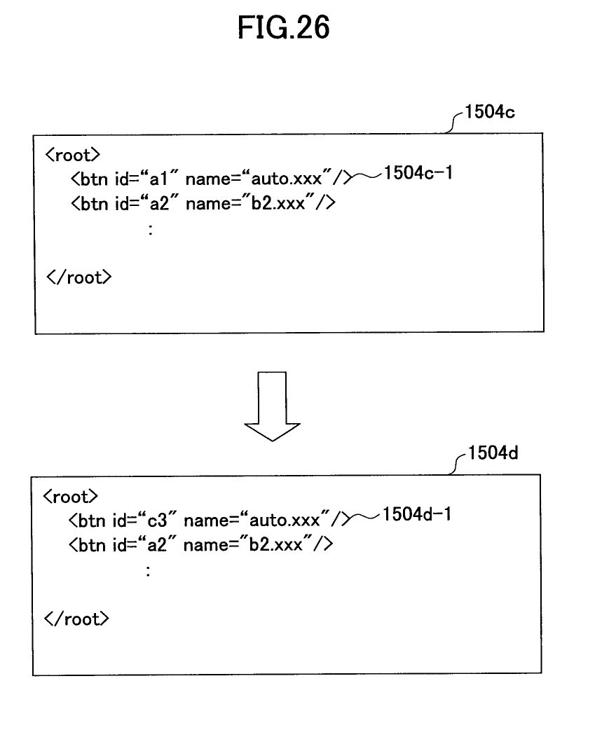

FIG. 26 is a diagram exemplifying update of the specification file 1504 in response to changes of the arrangement positions of the displaying parts.

In FIG. 26, a specification file 1504c represents the specification file 1504 prior to the change, and a specification file 1504d represents the specification file 1504 after the change.

In the specification file 1504c, an element 1504c-1 corresponds to the definition of the AUTO button 5311 prior to the change. In the specification file 1504d, an element 1504d-1 corresponds to the definition of the AUTO button 5311 after the change.

In the example shown in FIG. 26, it is illustrated that the ID of the AUTO button 5311 (auto.xxx) is changed from “a1” to “c3” in response to the instruction of changing the arrangement positions of the displaying parts.

In the above, it is exemplified that the customization of the operational screen image is performed on the operational panel of the image forming device 1, but the present embodiment is not limited to this. For example, the customization of the operational screen image can be performed remotely from a personal computer or other computers connected to the image forming device 1 through a network.

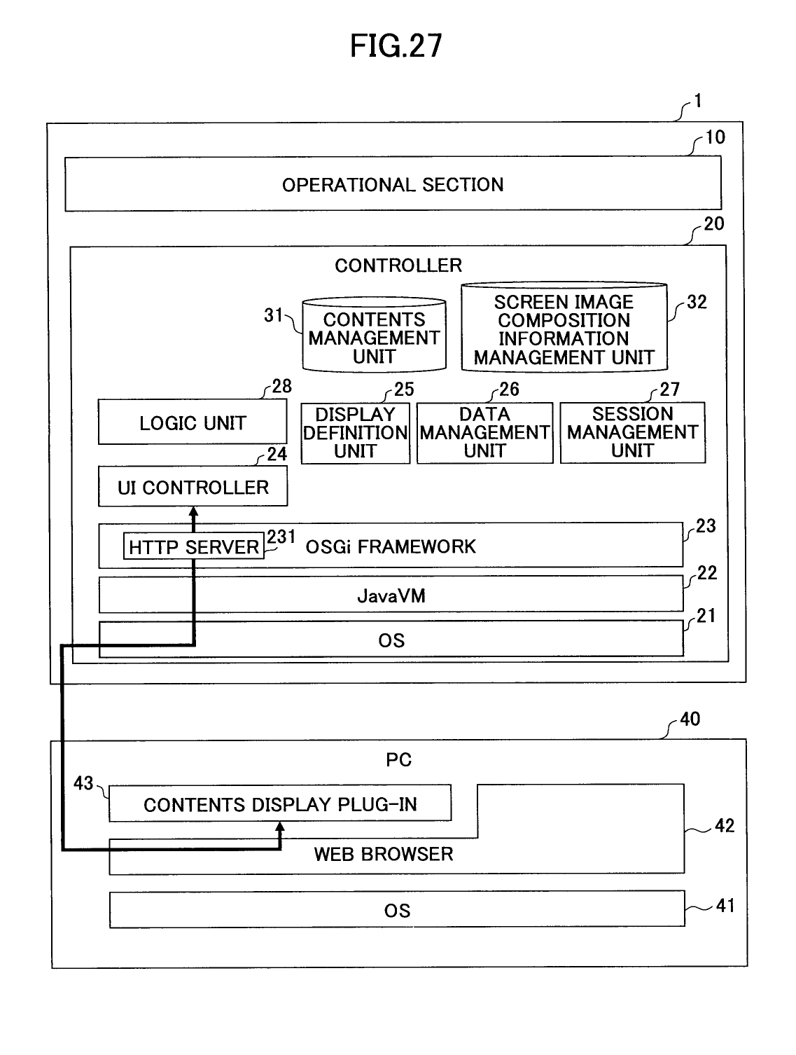

FIG. 27 is a block diagram exemplifying a configuration of the image forming device 1 capable of remote customization.

In FIG. 27, the same reference numbers are used for the same components in FIG. 3, and overlapping descriptions are omitted.

In FIG. 27, a PC 40 is connected to the image forming device 1 through a cable network or a radio network, and the PC 40 includes an OS 41, a Web browser 42, and a contents display plug-in 43.

The OS 41, the Web browser 42, and the contents display plug-in 43 can be the same software as the OS 11, the Web browser 12, and the contents display plug-in 13 of the operational section 10 in the image forming device 1, but it is not necessary that the OS 41 and the Web browser 42 be the same as the OS 11 and the Web browser 12 of the operational section 10 in the image forming device 1. In FIG. 27, for simplicity, illustration of the components of the operational section 10 is omitted.

According to the configuration as shown in FIG. 27, when the framework contents 14 and the displaying contents 15 corresponding to the customization setting screen image 510 and the copy UI setting screen image 530 are downloaded onto the contents display plug-in 43 of the PC 40 from the image forming device 1, it is possible to display the customization setting screen image 510 and the copy UI setting screen image 530 on the display device of the PC 40. By making operations on the screen image displayed on the display device of the PC 40, it is possible to customize various kinds of operational screen images by remote operations.

As described above, the image forming device 1 of the present embodiment according to the present invention displays kinds of operational screen images based on the screen image composition information (the specification file 1504, and the layout file 1505) defined for each of operational screen images. In addition, the displaying parts arranged on the operational screen image are managed as separate data (files). Thus, by changing the screen image composition information, it is possible to easily change (customize) display conditions of the operational screen images. For example, when it is desired to set a displaying part to be non-display, it is sufficient to delete the definition of the displaying part in the specification file 1504. In addition, when it is desired to change display conditions of a displaying part, it is sufficient to change the parts-file 1503 of the displaying part.

Further, since the screen image composition information is defined and managed for each user, it is possible to set display conditions of the operational screen images to depend on users.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Applications No. 2006-332446 filed on Dec. 8, 2006, and No. 2007-306422 filed on Nov. 27, 2007, the entire contents of which are hereby incorporated by reference.

What is claimed is:

1. An image forming device having an operational panel, comprising:
a composition information management unit configured to manage composition information of displaying parts to be arranged on each of a plurality of display screen images, said display screen images being to be displayed on the operational panel, said composition information of the displaying parts being managed in connection with each of the display screen images;
an arrangement information management unit configured to manage arrangement information of the displaying parts on each of the display screen images;
a displaying part management unit configured to manage displaying part data of each of the displaying parts; and
a display control unit configured to acquire the composition information and the arrangement information corresponding to one of the display screen images to be displayed, and the displaying part data of the displaying part defined by the composition information, and arrange the acquired displaying part in accordance with the arrangement information,
wherein
the display control unit changes display conditions of the display screen image according to at least one of the composition information, the arrangement information, and the displaying part data.

2. The image forming device as claimed in claim 1, further comprising:
a Web browser configured to execute display control of the display screen image on the operational panel;
wherein
the display control unit is constituted as plug-in contents of the Web browser.

3. The image forming device as claimed in claim 1, wherein at least one of the composition information, the arrangement information, and the displaying part data is defined in correspondence with a user.

4. The image forming device as claimed in claim 3, wherein
the display control unit displays the display screen image based on default composition information and default arrangement information when the user does not login, and updates the display screen image according to the composition information and the arrangement information in connection with the user when the user completes login.

5. The image forming device as claimed in claim 1, further comprising:
a control unit configured to control image formation processing in the image forming device according to operations performed on the display screen image;
wherein
the display control unit notifies the control unit of the operations performed on the display screen image, receives at least one of the composition information, the arrangement information, and the displaying part data from the control unit as a response of the notification, and changes the display conditions of the display screen image according to at least one of the composition information, the arrangement information, and the displaying part data.

6. A display control method for controlling an image forming device having an operational panel, said method comprising:
a composition information management step of managing composition information of displaying parts to be arranged on each of a plurality of display screen images, said display screen images being to be displayed on the operational panel, said composition information of the displaying parts being managed in connection with each of the display screen images;
an arrangement information management step of managing arrangement information of the displaying parts on each of the display screen images;
a displaying part management step of managing displaying part data of each of the displaying parts; and
a display control step of acquiring the composition information and the arrangement information corresponding to one of the display screen images to be displayed, and the displaying part data of the displaying part defined by the composition information, and arranging the acquired displaying part in accordance with the arrangement information,
wherein
in the display control step, display conditions of the display screen image are changed according to at least one of the composition information, the arrangement information, and the displaying part data.

7. The display control method as claimed in claim 6,
wherein the display control step is constituted to be plug-in contents of a Web browser for executing display control of the display screen image on the operational panel.

8. The display control method as claimed in claim 6, wherein at least one of the composition information, the arrangement information, and the displaying part data is defined in correspondence with a user.

9. The display control method as claimed in claim 8, wherein
in the display control step, the display screen image is displayed based on default composition information and default arrangement information when the user does not login, and when the user completes login, the display screen image is updated according to the composition information and the arrangement information in connection with the user.

10. The display control method as claimed in claim 6, further comprising:
a control step of controlling image formation processing in the image forming device according to operations performed on the display screen image,
wherein
in the display control step, operations performed on the display screen image are reported to the control step,
at least one of the composition information, the arrangement information, and the displaying part data are received from the control step by the display control step as a response of the report, and the display conditions of the display screen image are changed according to at least one of the composition information, the arrangement information, and the displaying part data.

11. A computer program product for controlling an image forming device having an operational panel, comprising computer code for executing:
a composition information management step of managing composition information of displaying parts to be arranged on each of a plurality of display screen images, said display screen images being to be displayed on the operational panel, said composition information of the displaying parts being managed in connection with each of the display screen images;
an arrangement information management step of managing arrangement information of the displaying parts on each of the display screen images;
a displaying part management step of managing displaying part data of each of the displaying parts; and
a display control step of acquiring the composition information and the arrangement information corresponding to one of the display screen images to be displayed, and the displaying part data of the displaying part defined by the composition information, and arranging the acquired displaying part in accordance with the arrangement information,
wherein
in the display control step, display conditions of the display screen image are changed according to at least one of the composition information, the arrangement information, and the displaying part data.

12. The computer program product as claimed in claim 11,
wherein the display control step is constituted as plug-in contents of a Web browser for executing display control of the display screen image on the operational panel.

13. The computer program product as claimed in claim 11, wherein at least one of the composition information, the arrangement information, and the displaying part data is defined in correspondence with a user.

14. The computer program product as claimed in claim 13, wherein
in the display control step, the display screen image is displayed based on default composition information and default arrangement information when the user does not login, and when the user completes login, the display screen image is updated according to the composition information and the arrangement information in connection with the user.

15. The computer program product as claimed in claim 11, further comprising computer code for executing:
a control step of controlling image formation processing in the image forming device according to operations performed on the display screen image,
wherein
in the display control step, operations performed on the display screen image are reported to the control step,
at least one of the composition information, the arrangement information, and the displaying part data are received from the control step to the display control step as a response of the report, and the display conditions of the display screen image are changed according to at least one of the composition information, the arrangement information, and the displaying part data.
